(19) United States
(12) Patent Application Publication
(10) Pub. No.: US 2017/0249635 A1
(43) Pub. Date: Aug. 31, 2017

(54) TRANSACTION AUTHORIZATION SYSTEM FOR VEHICLE

(71) Applicant: MAGNA MIRRORS OF AMERICA, INC., Holland, MI (US)

(72) Inventor: Michael J. Baur, Kentwood, MI (US)

(21) Appl. No.: 15/440,416

(22) Filed: Feb. 23, 2017

Related U.S. Application Data
(60) Provisional application No. 62/300,228, filed on Feb. 26, 2016.

(51) Int. Cl. G06Q 20/40; G06K 7/10

(52) U.S. Cl. CPC G06Q 20/401; G06K 7/10366

(57) ABSTRACT

A transaction authorization system for a vehicle includes a radio frequency identification (RFID) device disposed in the vehicle. When the vehicle is located within a field of sensing of a sensing device of an RFID sensing system, the RFID sensing system is operable to recognize the RFID device. The RFID sensing system, responsive to recognition of the RFID device, is operable to wirelessly communicate with a remote server to at least one of (i) authorize a transaction pertaining to the vehicle and (ii) authorize a transaction pertaining to a user of the vehicle.

### CROSS REFERENCE TO RELATED APPLICATION

The present application claims the filing benefits of U.S. provisional application Ser. No. 62/300,228, filed Feb. 26, 2016, which is hereby incorporated herein by reference in its entirety.

### FIELD OF THE INVENTION

The present invention relates generally to the field of vehicles that have communication systems therein.

### BACKGROUND OF THE INVENTION

Currently, some vehicles are fitted with aftermarket equipment to enable automatic toll collection. This is typically accomplished by use of a RF (Radio Frequency) system that is unique to each vehicle/user. The RF identification (RFID) tag on the vehicle typically syncs to information stored within a remote secure sever that is managed and maintained by a private or semi-public entity such as a toll authority. This system provides cyber security by allowing only the RFID information to be kept accessible. All other information is kept within secure servers.

### SUMMARY OF THE INVENTION

The present invention provides a permanent incorporation of a Radio Frequency Identification (RFID) system or device into a vehicle that can establish the use of RFID access to provide transaction authorization for a much broader scope transactions involving vehicles.

In accordance with an aspect of the present invention, the transaction authorization system of the present invention includes a radio frequency identification (RFID) device disposed in the vehicle and associated with an identification of that vehicle. When the vehicle is located within a field of sensing of a sensing device of an RFID sensing system, the RFID sensing system is operable to sense and detect and recognize the RFID device. The RFID sensing system, responsive to recognition of the RFID device, is operable to wirelessly communicate with a remote server to at least one of (i) authorize a transaction (such as a payment in return for goods or services) pertaining to the vehicle and (ii) authorize a transaction (such as a payment in return for goods or services) pertaining to a user of the vehicle.

These and other objects, advantages, purposes and features of the present invention will become apparent upon review of the following specification in conjunction with the drawings.

### BRIEF DESCRIPTION OF THE DRAWINGS

FIG. 1 is a perspective view of a vehicle having an RFID system in accordance with the present invention; and

FIG. 2 is a block diagram of the RFID sensing system of the present invention.

### DESCRIPTION OF THE PREFERRED EMBODIMENTS

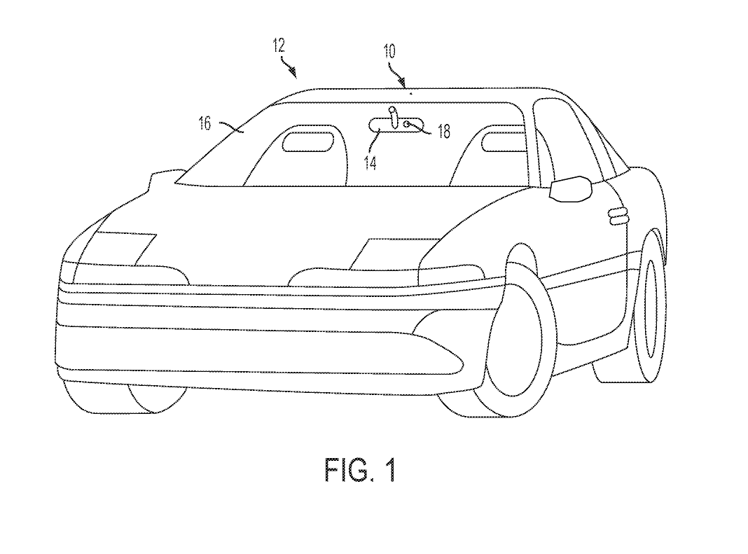

Referring now to the drawings and the illustrative embodiments depicted therein, a transaction authorization system or RFID device or system 10 of the present invention is disposed at a vehicle 12, such as at an interior rearview mirror assembly 14 attached at an in-cabin surface of a vehicle windshield 16 (FIG. 1). The transaction authorization system 10 includes an RFID chip or element 18 that, in the illustrated embodiment, is disposed at the interior rearview mirror assembly 14 of the vehicle. However, the RFID device or element or system may be disposed elsewhere at or in the vehicle, such as at an exterior rearview mirror assembly of the vehicle or at or in the dashboard of the vehicle or engine compartment of the vehicle or the like, while remaining within the spirit and scope of the present invention.

The transaction authorization system or RFID system 10 provides a permanent incorporation of an RFID system into a vehicle. For example, the RFID device or element may be associated with the vehicle identification number (VIN), and the RFID device may be installed in the vehicle (and associated with that vehicle) at the vehicle assembly plant. The transaction authorization or RFID system 10 provides RFID access, such as to provide payment authorization or the like, for a much broader scope of transactions involving vehicles. For example, if gas stations were equipped with a compatible system (such as a system similar to or compatible with the current toll collections systems), a vehicle operator (of a vehicle with the RFID system of the present invention incorporated therein) would not require any other form of payment at the gas station.

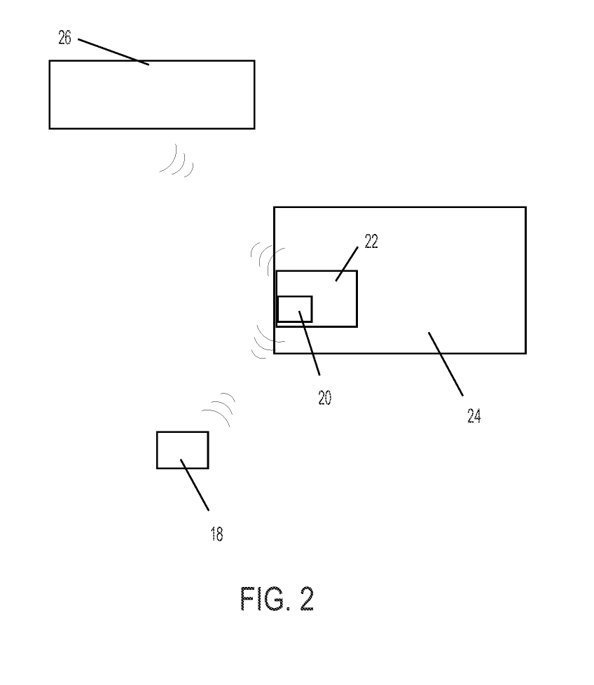

In the illustrated embodiment, and such as shown in FIG. 2, the transaction authorization system of the present invention includes a radio frequency identification (RFID) device 18 disposed in the vehicle and associated with an identification of that vehicle. A sensing device 20 of an RFID sensing system 22 is disposed at a facility 24 that provides goods or services in return for payment. When the vehicle is located within a field of sensing of the sensing device 20 of the RFID sensing system 22, the RFID sensing system senses and detects and recognizes the RFID. The RFID sensing system, responsive to recognition of the RFID device, is operable to wirelessly communicate with a remote server 26 to at least one of (i) authorize payment pertaining to the vehicle and (ii) authorize payment pertaining to a user of the vehicle.

Current methods of payment at the gas stations are known to be compromised by various criminal activities involving fraud and identity theft. Because the RFID system 10 for the vehicle is built securely into the vehicle, the vehicle will need to be present. Additionally, the secure server could also require a PIN code or other password protection to work in configuration with the RFID code. By using these two systems in tandem, security is increased and installation if simplified.

By incorporating the RFID system 10 into the vehicle in a permanent manner, only RFID information is available and it is only available if the vehicle is present. The RFID element 18 may be static (in other words, fixedly disposed in the vehicle) or it may be dynamic or removable and transportable (such as a secure token or the like that may be plugged into the vehicle when used in the vehicle but may be removed from the vehicle if desired). These measures taken together can make the refueling experience more secure and easier. In addition, the management of fleet vehicle refueling becomes easier to manage as well.

The vehicle-based RFID system of the present invention can be applied in a number of other cases as well. For example, billing for drive-thru food (or other drive-thru structures), vehicle maintenance, car washes and the like can be easily adapted to the RFID system of the present invention.

In the illustrated embodiment, the RFID system 10 includes an RFID chip or element 18 that is disposed at the interior rearview mirror assembly 14 at the windshield 16 of the vehicle. Locating the RFID information at the rearview mirror or windshield area provides a number of benefits. For example, the location is RF friendly, since the device can receive/transmit RF signals through the windshield. The location is also consistent with the driver position and vehicle location, and the location is readily accessible and serviceable.

For example, and in accordance with the present invention, an RFID device is disposed within an interior rearview mirror assembly of a vehicle (or elsewhere, such as in an exterior rearview mirror assembly or a door handle of the vehicle) and provides identification information pertaining to or specific to the particular equipped vehicle and/or the user or owner of the vehicle. When the equipped vehicle is approaching the likes of a toll booth, and is within the field of sensing and the sensing range of an RFID sensing system disposed at or in the toll booth (or at or in an overhead gantry that traverses the road and that traffic traveling on the road passes under), the RFID sensing system recognizes the RFID device, and thus recognizes the identity of the equipped vehicle and/or the identity of a user of the equipped vehicle, and responsive to such recognition, wirelessly communicates with a toll payment center or server (such as via a cloud communication or the like) where payment of the required toll is both authorized and made.

The RFID device or tag disposed at the equipped vehicle (such as at or within an interior rearview mirror assembly or an exterior mirror assembly or a door handle assembly) can be either passive, active or battery-assisted passive. If an active tag, the RFID device has an on-board battery and periodically transmits its identification signal. If it is a battery-assisted passive RFID, it has a small battery on board and is activated when in the field of sensing of the remote RFID sensor of the RFID sensing system. If the RFID device is a passive tag, the RFID device disposed at the equipped vehicle is powered by the sensing signal being transmitted from the remote RFID sensor of the RFID sensing system.

The RFID device or tag may be read-only or may be read/write. The RFID device or tag disposed at the equipped vehicle preferably comprises at least: (i) an integrated circuit for storing and processing information, modulating and demodulating a radio-frequency (RF) signal, and collecting DC power from the incident sensing signal being transmitted from the remote RFID sensor of the RFID sensing system, and (ii) an antenna for receiving and transmitting signals. Tag information is stored in a non-volatile memory. The RFID tag includes either fixed or programmable logic for processing the transmission and sensor data, respectively.

The RFID tag thus provides identification of the user/vehicle, whereby the RFID sensing system can identify the user/vehicle and can obtain authorization for the respective transaction. The transaction authorization thus allows the system to complete a transaction (e.g., toll payment or the like). Optionally, the RFID device may transmit a signal that is received by the RFID sensing system and that specifies aspects of the desired or respective transaction. Optionally, the RFID device may be programmable by the user to transmit a desired or selected signal, such as to make an order at a drive-thru or the like, whereby the RFID sensing system receives the order and communicates the order to the facility or drive-thru and, via communication with the remote server, obtains authorization for payment of the ordered goods. Optionally, a specific order may be transmitted via other communication devices of the vehicle (or via the user's cellular phone or the like) so that the order is made to the drive-thru (or other facility) via one communication system and transaction authorization is obtained via the RFID communication system. The RFID system thus may identify the vehicle or user and associate that identified vehicle/user with an order of food or other goods/services, and may obtain transaction authorization for that transaction so that the user, upon arrival at the drive-thru or other facility, can simply pick up the ordered goods and proceed, without having to provide further payment at that time.

More enhanced technologies also benefit from the present invention. For example, BLUETOOTH® or Wi-Fi could also be utilized to accomplish the RFID system but could have enhanced capability due to the ability to send and receive. Overall, by incorporating the system information into the vehicle in accordance with the present invention, security and convenience is enhanced.

The system of the present invention may utilize various aspects of the systems described in U.S. Pat. Nos. 9,264,673; 7,308,341 and/or 6,693,517, and/or U.S. Publication Nos. US-2014-0293169; US-2015-0124096; US-2015-0251599 and/or US-2016-0288647, and/or International Publication No. WO 2016/044706, which are hereby incorporated herein by reference in their entireties.

The RFID system of the present invention may include one or more user inputs (such as for activating/deactivating the system and/or entering a passcode or the like). For example, the mirror assembly may include user actuatable inputs operable to control any of the RFID system and/or other accessories of or associated with the mirror assembly and/or an accessory module or the like. For example, the mirror assembly may include touch sensitive elements or touch sensors or proximity sensors, such as the types of touch sensitive elements described in U.S. Pat. Nos. 5,594,222; 6,001,486; 6,310,611; 6,320,282; 6,627,918; 7,224,324 and/or 7,253,723, and/or International Publication Nos. WO 2012/051500 and/or WO 2013/071070, which are hereby incorporated herein by reference in their entireties, or such as proximity sensors of the types described in U.S. Pat. Nos. 7,224,324; 7,249,860 and/or 7,446,924, and/or International Publication No. WO 2004/058540, which are hereby incorporated herein by reference in their entireties, or such as membrane type switches, such as described in U.S. Pat. No. 7,360,932, which is hereby incorporated herein by reference in its entirety, or such as detectors and the like, such as the types disclosed in U.S. Pat. Nos. 7,255,541; 6,504,531; 6,501,465; 6,492,980; 6,452,479; 6,437,258 and/or 6,369,804, which are hereby incorporated herein by reference in their entireties, and/or the like, while remaining within the spirit and scope of the present invention.

Optionally, the user inputs or buttons may comprise user inputs for a garage door opening system, such as a vehicle based garage door opening system of the types described in U.S. Pat. Nos. 6,396,408; 6,362,771; 7,023,322 and/or 5,798,688, which are hereby incorporated herein by reference in their entireties. Optionally, the user inputs may also or otherwise comprise user inputs for a telematics system of the vehicle, such as, for example, an ONSTAR® system as found in General Motors vehicles and/or such as described in U.S. Pat. Nos. 4,862,594; 4,937,945; 5,131,154; 5,255,442; 5,632,092; 5,798,688; 5,971,552; 5,924,212; 6,243,003; 6,278,377; and 6,420,975; 6,477,464; 6,946,978; 7,308,341; 7,167,796; 7,004,593; 7,657,052 and/or 6,678,614, and/or U.S. Pat. Pub. No. US-2006-0050018, which are all hereby incorporated herein by reference in their entireties.

Optionally, the mirror assembly may include one or more other displays, such as the types disclosed in U.S. Pat. Nos. 8,890,955; 7,855;755; 7,338,177; 7,274,501; 7,255,451; 7,195,381; 7,184,190; 7,046,448; 5,668,663; 5,724,187; 5,530,240; 6,329,925; 6,690,268; 7,734,392; 7,370,983; 6,902,284; 6,428,172; 6,420,975; 5,416,313; 5,285,060; 5,193,029 and/or 4,793,690, and/or in U.S. Pat. Pub. Nos. US-2006-0050018; US-2009-0015736; US-2009-0015736; and/or US-2010-0097469, which are all hereby incorporated herein by reference in their entireties.

Optionally, the accessory or accessories, such as those described above, may be positioned at or within the mirror casing and/or mirror cap portion or the like, and may be included on or integrated in a printed circuit board positioned within the mirror casing and/or cap portion, such as along a rear surface of the reflective element or elsewhere within a cavity defined by the casing, without affecting the scope of the present invention. The user actuatable inputs and/or touch sensors and/or proximity sensors and displays described above may be actuatable to control and/or adjust the accessories of the mirror assembly/system and/or overhead console and/or accessory module and/or vehicle. The connection or link between the controls and the display screen device and/or the navigation system and/or other systems and accessories of the mirror system may be provided via vehicle electronic or communication systems and the like, and may be connected via various protocols or nodes, such as BLUETOOTH®, SCP, UBP, J1850,CAN J2284, Fire Wire 1394, MOST, LIN, FlexRay™, Byte Flight and/or the like, or other vehicle-based or in-vehicle communication links or systems (such as Wi-Fi and/or IRDA) and/or the like, or via VHF or UHF or other wireless transmission formats, depending on the particular application of the mirror/accessory system and the vehicle. Optionally, the connections or links may be provided via various wireless connectivity or links, without affecting the scope of the present invention.

Changes and modifications in the specifically described embodiments may be carried out without departing from the principles of the present invention, which is intended to be limited only by the scope of the appended claims as interpreted according to the principles of patent law.

1. A transaction authorization system for a vehicle, said transaction authorization system comprising:
a radio frequency identification (RFID) device disposed in an equipped vehicle;
wherein, when the equipped vehicle is located within a field of sensing of a sensing device of an RFID sensing system, said RFID sensing system is operable to recognize said RFID device; and
wherein said RFID sensing system, responsive to recognition of said RFID device, wirelessly communicates with a remote server to at least one of (i) authorize a transaction pertaining to the equipped vehicle and (ii) authorize a transaction pertaining to a user of the equipped vehicle.

2. The transaction authorization system of claim 1, wherein said RFID device is disposed at an interior rearview mirror assembly of the equipped vehicle.

3. The transaction authorization system of claim 1, wherein said RFID device is disposed at an exterior rearview mirror assembly of the equipped vehicle.

4. The transaction authorization system of claim 1, wherein said RFID device is fixedly disposed at the equipped vehicle and is associated with an identification of the equipped vehicle.

5. The transaction authorization system of claim 1, wherein said sensing device of said RFID sensing system is disposed at a facility that provides goods or services in return for payment.

6. The transaction authorization system of claim 5, wherein said sensing device of said RFID sensing system is disposed at one of a gas station, a drive-thru, a toll booth and a service station.

7. The transaction authorization system of claim 5, wherein said RFID sensing system accesses the remote server to obtain payment information for goods or services provided by the facility.

8. The transaction authorization system of claim 7, wherein said RFID sensing system accesses the remote server to obtain payment information for gas, food, tolls or services rendered.

9. The transaction authorization system of claim 5, wherein said sensing device of said RFID sensing system is disposed at a gas station and wherein said RFID sensing system accesses the remote server to obtain payment information for gas provided at the gas station.

10. The transaction authorization system of claim 5, wherein said sensing device of said RFID sensing system is disposed at a drive-thru and wherein said RFID sensing system accesses the remote server to obtain payment information for food provided at the drive-thru powered by a sensing signal transmitted from said sensing device of said RFID sensing system.

11. The transaction authorization system of claim 1, wherein said RFID device comprises a passive RFID device powered by a signal transmitted by a sensing device of said RFID sensing system.

12. The transaction authorization system of claim 1, wherein said RFID device comprises an active RFID device comprising a battery and operable to periodically transmit an identification signal.

13. The transaction authorization system of claim 1, wherein said RFID device comprises a battery-assisted passive RFID device comprising a battery and activated when in the field of sensing of said sensing device of said RFID sensing system.

14. A transaction authorization system for a vehicle, said transaction authorization system comprising:
a radio frequency identification (RFID) device disposed in an equipped vehicle and associated with an identification of the equipped vehicle;
wherein, when the equipped vehicle is located within a field of sensing of a sensing device of an RFID sensing system, said RFID sensing system is operable to recognize said RFID device;
wherein said sensing device of said RFID sensing system is disposed at a facility that provides goods or services in return for payment; and
wherein said RFID sensing system, responsive to recognition of said RFID device, is operable to wirelessly communicate with a remote server to at least one of (i) authorize payment pertaining to the equipped vehicle and (ii) authorize payment pertaining to a user of the equipped vehicle.

15. The transaction authorization system of claim 14, wherein said RFID device comprises a passive RFID device powered by a signal transmitted by a sensing device of said RFID sensing system.

16. The transaction authorization system of claim 14, wherein said RFID device comprises an active RFID device comprising a battery and operable to periodically transmit an identification signal.

17. The transaction authorization system of claim 14, wherein said RFID device comprises a battery-assisted passive RFID device comprising a battery and activated when in the field of sensing of said sensing device of said RFID sensing system.

18. A transaction authorization system for a vehicle, said transaction authorization identification system comprising:
a radio frequency identification (RFID) device disposed in an equipped vehicle and associated with an identification of the equipped vehicle;
wherein said RFID device is disposed at one of (i) an interior rearview mirror assembly of the equipped vehicle and (ii) an exterior rearview mirror assembly of the equipped vehicle;
wherein, when the equipped vehicle is located within a field of sensing of a sensing device of an RFID sensing system, said RFID sensing system is operable to recognize said RFID device;
wherein said sensing device of said RFID sensing system is disposed at a facility that provides goods or services in return for payment;
wherein said RFID sensing system, responsive to recognition of said RFID device, is operable to wirelessly communicate with a remote server to at least one of (i) authorize a transaction pertaining to the equipped vehicle and (ii) authorize a transaction pertaining to a user of the equipped vehicle; and
wherein the authorized transaction is a transaction selected by the user of the equipped vehicle and communicated to the facility via a communication from the user or the equipped vehicle.

19. The transaction authorization system of claim 18, wherein said sensing device of said RFID sensing system is disposed at one of a gas station, a drive-thru, a toll booth and a service station, and wherein said RFID sensing system accesses the remote server to obtain payment information for the selected gas, food, tolls or services communicated by the user or the equipped vehicle.

20. The transaction authorization system of claim 18, wherein said RFID device comprises one of (i) a passive RFID device powered by a signal transmitted by a sensing device of said RFID sensing system, (ii) an active RFID device comprising a battery and operable to periodically transmit an identification signal, and (iii) a battery-assisted passive RFID device comprising a battery and activated when in the field of sensing of said sensing device of said RFID sensing system.
